(19) United States
(12) Patent Application Publication
(10) Pub. No.: US 2003/0061929 A1
(43) Pub. Date: Apr. 3, 2003

(54) Percussion instrument

(76) Inventors: Mary A. Dye, Oak Park, IL (US); Atiba Johnson, Chicago, IL (US)

Correspondence Address: BRINKS HOFER GILSON & LIONE, P.O. BOX 10395, CHICAGO, IL, 60610, US

(21) Appl. No.: 09/971,109

(22) Filed: Oct. 3, 2001

(51) Int. Cl. G10D 13/02

(52) U.S. Cl. 84/411 R

(57) ABSTRACT

A percussion instrument having a body comprising a first, second and third section each defining respectively a first, second and third chamber. The first section is connected to the second section, which is connected to the third section, with the second chamber communicating with the first and third chambers. The first chamber has an opening formed in one end thereof. A membrane is secured over the opening. The third chamber has an opening formed therein that preferably is exposed. The third chamber preferably has a cross-sectional area greater than the area of the opening formed therein, and more preferably has a spherical shape. A method of playing the instrument comprises striking the membrane. In preferred embodiments, the method further comprises placing a barrier member adjacent the opening of the third chamber, preferably in conjunction with the striking of the membrane, and/or variously moving the barrier member toward and away from the opening of said third chamber. In yet another embodiment, the method comprises striking the opening in the third chamber.

### BACKGROUND

The present invention relates generally to percussion instruments, and in particular, to a drum having two different methods of sound production.

In general, drums fall into a class of percussion instruments known as membranophones. Although some drums allow for the manipulation of pitch, the sounds produced by any individual drum are generally limited to those made by striking the head of the drum in various manners. Often, a membrane is stretched over an opening to form the head of the drum. In some cases, membranes are stretched over openings formed on opposite ends of the drum to form a double-headed drum. Typically, such drums are configured with a single chamber.

Drums also can be configured without heads. For example, an Udu drum typically has two exposed openings, one or both of which can be struck by the user. Such drums can be configured with one or more chambers. Other drums can be configured with two openings, but with one of the opening being covered with a head. For example, a Dumbek drum typically has an hourglass shape, with an upper chamber being covered with a head and a base portion that flares out and is open at the end thereof.

Conventional drums such as these typically are capable of producing only one type of sound, e.g., by striking one or more heads or by striking one or more exposed openings communicating with a chamber.

### SUMMARY

Briefly stated, in one aspect, the present invention is directed to a percussion instrument having a first, second and third section defining respectively a first, second and third chamber. The first chamber has a first and second opening formed on opposite ends thereof. A membrane is secured over the first opening of the first chamber. The second chamber has a first and second opening on opposite ends thereof, with the first opening of the second chamber communicating with the second opening of the first chamber. The third chamber has a first and second opening formed on opposite ends thereof, with the first opening of the third chamber communicating with the second opening of the second chamber. The second opening of the third chamber preferably remains exposed to a user. The third chamber has a maximum cross-sectional area. The second opening of the third chamber defines an area that is smaller than the maximum cross-section area of the third chamber.

In a preferred embodiment, the third chamber has a spherical shape. In a more preferred embodiment, the second section has a substantially tubular shape and the first section has a substantially frusto-conical shape.

In another aspect, a method of playing the instrument includes striking at least a portion of the membrane. In further preferred embodiments, the method further includes placing a barrier member adjacent the second opening of the third chamber, and moving the barrier member toward and away from the second opening of the third chamber. In yet another aspect, the method further includes striking the second opening of the third chamber with a barrier member, and preferably striking the second opening such that the entirety of the second opening of the third chamber is covered.

The present invention provides significant advantages over other drums. In particular, the drum allows the user to produce two different classes of sound using only one instrument. In addition, the user can combine two fundamentally different methods of sound production using only one instrument. The first method uses the membrane, or head, of the drum. The other method uses the resonant cavity of the drum body to create an entirely different sound. The present invention also is designed to produce sound in a fully chromatic range of pitches and a wide variety of timbres. The various sounds produced by the instrument can be easily achieved and controlled without making any physical changes to the instrument itself. Furthermore, the invention is small and lightweight, simple in construction and easily transportable.

### BRIEF DESCRIPTION OF SEVERAL VIEWS OF THE DRAWINGS

FIG. 1 is a perspective view of a drum.

FIG. 2 is an end view of the drum.

FIG. 3 is an opposite end view of the drum.

FIG. 4 is a side view of the drum.

FIG. 5 is schematic cross-sectional illustration of the drum.

### DETAILED DESCRIPTION OF THE PRESENTLY PREFERRED EMBODIMENTS

Referring to FIGS. 1, 4 and 5, a drum 2 includes a body 4 having a first, second and third section 6, 8, 10. The first section 6 has an interior surface 12 defining a chamber 14. The first section 6 preferably has a lower portion 16 with a frusto-conical shape and an upper portion defining a curved rim. It should be understood that the first section can have numerous other shapes including for example various curvilinear surfaces, such as a convex or concave exterior. It should also be understood that although the first section 16 preferably has a circular cross-section which is taken substantially perpendicular to a longitudinally extending axis 20, the first section could have alternative cross-sectional shapes, including for example various rectangles, triangles, and ellipses, or any other shape. The first section 6 has opposite ends 22 terminating in a first opening 26 and a second opening 28 respectively, with the first opening 26 preferably being larger than the second opening 28 and having a greater cross-sectional area than the second opening 28. In a preferred embodiment, the width of the second opening 28 is preferably not more than ½ and not less than ¼ of the width of the first opening 26. The first and second openings 26, 28 are preferably circular, although it should be understood that they can assume other shapes. The first section 6 is tapered from the first end 22 to the second 24 end, with the first end 22 having a greater width than the second end 24.

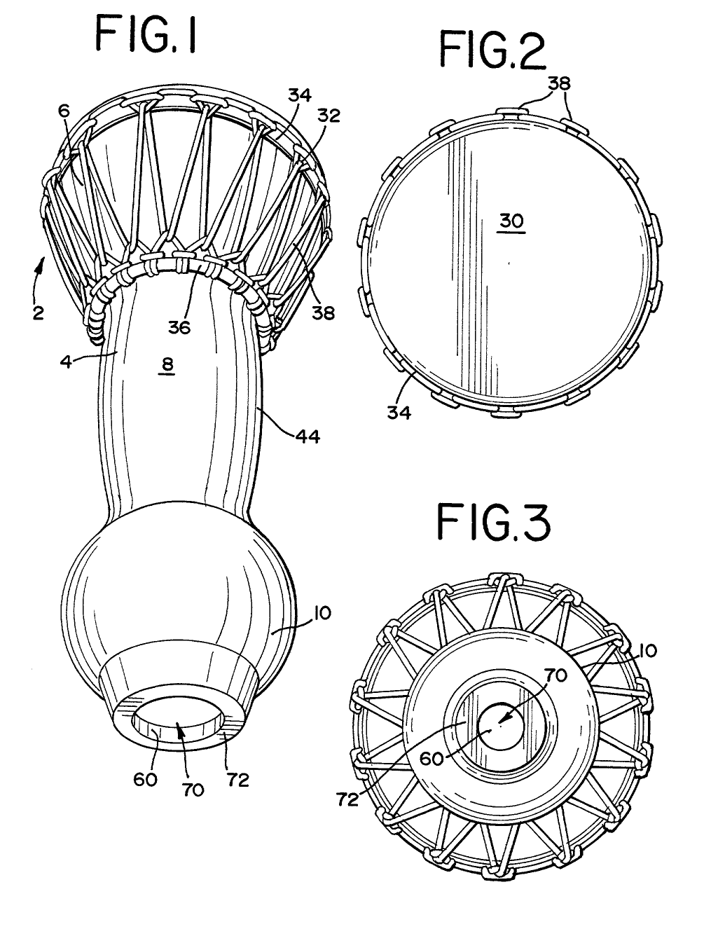

Referring to FIGS. 1, 2, 4 and 5, a membrane 30 is secured over the first opening 26 to form a head of the drum. The membrane 30 is preferably elastic and is made of any material that can be tensioned across the opening and which will vibrate when struck. For example, and without limitation, the membrane can be made of synthetic materials, natural or synthetic fabrics, animal skin or vellum-type materials, or other types of materials known to those of skill in the art. The membrane 30 includes a plurality of openings 32 formed around a periphery 34 thereof. A retaining ring 36 is secured around the lower end 24 of the first section 6 adjacent a junction 40 between the first and second sections 6, 8. The ring 36 is held in place adjacent the second end 24 by the tapered configuration of the first section 6. One or more tensioning members 38, preferably configured as a cord, are interwoven between the plurality of openings 32 formed in the membrane 30 and the retaining ring 36. The tensioning member can be drawn tight between the membrane 30 and the ring 36 so as to stretch the membrane 30 tight against the edge 42 of the rim 18 of the first section 6 as it is secured over the opening 26. The ends of the tensioning member 38 can be tied to retain the tensioning member and membrane in tension. The amount of tension in the tensioning member can be adjusted to provide varying degrees of tension in the membrane 30 or head of the drum so as to alter the sound and tone of the drumhead as desired. It should be understood that the membrane could be drawn tight over the rim 18 of the first section 6 using other devices such as tensioning screws, adhesives, and other types of mechanical fasteners, or any other device or method known to those of skill in the art.

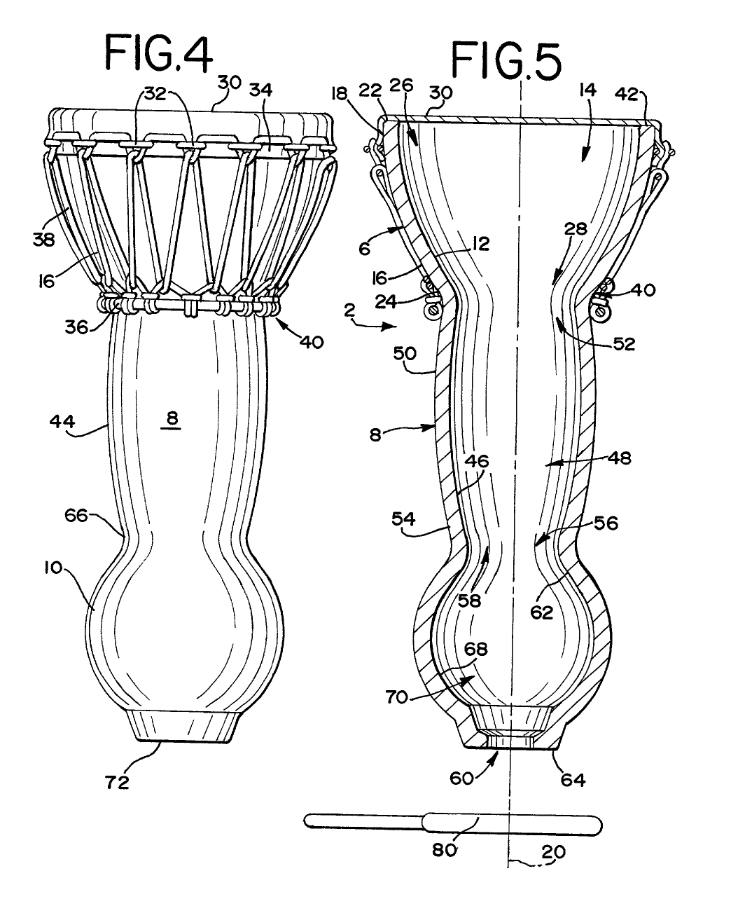

The second section 8 is preferably tubular, and preferably has a substantially cylindrical shape. As shown in FIG. 4, the second section 8 has a slightly convex exterior surface 44 relative to the longitudinally extending axis 20 defining the centerline of the instrument. It should be understood that in alternative embodiments the exterior surface 44 could be concave or relatively flat, or assume any other shape, including various curvilinear shapes, relative to the centerline of the instrument. The second section 8 has an interior surface 46 defining a tubular chamber 48. The second section 8 has a first end 50 connected to the second end 24 of the first section at junction 40. The first end 50 of the second section has an opening 52 communicating with the opening 28 of the first section and a second end 54 having an opening 56. In one preferred embodiment, the opening 56 may be slightly less, and preferably not more than the width of the opening 52, which is preferably the same size of the opening 28. On preferred inner diameter of the second section is approximately the same as the opening 28.

The third section 10 preferably is generally spherical. Of course, it should be understood that the third section can be configured in any number of different shapes, including various elliptical, oblong, and rectangular shapes, for example. The third section 10 has a first and second opening 58, 60, formed on opposite ends 62, 64, thereof. The first end 62 of the third section 10 is connected to the second end 54 of the second section 8 at a junction 66 such that the first opening 58 of the third section communicates with the second opening 56 of the second section 8. The third section 10 has an interior surface 68 defining a chamber 70. The chamber 70 has a maximum cross-sectional area measured substantially perpendicular to the longitudinal axis. In the preferred embodiment, the maximum area is equal to

$${π ( \frac{d}{2} )}^{2}$$

where d is the internal diameter of the chamber 70. The maximum cross-sectional area is preferably greater than the area defined by the second opening 60 formed on the end 64 of the third section. The first and second openings 58, 60 are preferably circular, although it should be understood that the openings can be configured in other shapes. As best shown in FIGS. 1, 3 and 4, the third section 10 preferably includes a substantially flat rim or platform 72 formed around the second opening. The second opening 60, which functions as a sound hole, preferably remains exposed such that 60 is not covered with any membrane or other type of head. In a preferred embodiment, the opening 60 has a width that is easily sealed with a barrier member, e.g., the palm of a user's hand, and preferably has a width of from about 1.5 inches to about 3.0 inches.

Preferably, the first, second and third sections 6, 8 10 are integrally formed as a single continuous body, wherein the junction 40 between the first and second sections 6, 8 defines an opening therebetween, and wherein the junction 66 between the second and third sections 8, 10 defines an opening therebetween. Alternatively, each of the first, second and third sections can be made separately and thereafter be connected with the various openings 28, 52, 56, 58 communicating as explained above. Preferably, the first, second and third sections are arranged as shown in FIGS. 1, 4 and 5 such that the preferably circular cross-sections thereof and the openings formed therein are coaxially spaced and aligned along the longitudinal axis 20. In a preferred embodiment, the overall length of the drum is preferably between about 1 foot and 3 feet, although it should be understood that the drum can be made with a greater or lesser length.

Preferably, the first, second and third sections are made of ceramic. Each of the sections can be made of different colors, or can be engraved or configured with different designs or patterns as desired for aesthetics. Alternatively, in other preferred embodiments, the various sections can be made of wood, metal, fiberglass or other rigid material, or any material known to those of skill in the art, depending on the acoustical properties desired and the manufacturing feasibility and advantages realized from the use of those various materials.

In use, the drum produces sound in two different ways. In one sequence, the user strikes the membrane 30, or head, of the drum with a hand, fingers, stick or other mallet designed for this purpose. Striking the head causes it to vibrate. This vibration in turn is transferred into the surrounding air, which includes the column of air enclosed by the body of the drum. The various chambers 14, 48, 70 of the drum sustain and amplify these vibrations. In particular, the configuration of the chambers affects the sound by dampening vibrations that are not whole integer multiples of the lowest vibration produced by the drum (i.e., the fundamental), and enhancing those that are.

In an alternative sequence, the user strikes the rim or platform 72 defining the second opening 60, or sound hole 64, formed in the end of the third section 10 with a barrier member 80, such as a palm of the hand or a paddle designed for this purpose. To produce sound using the sound hole 60 alone, i.e., without simultaneous use of the drum head 30, the user preferably strikes the sound hole 60 at right angles to the longitudinal axis 20 of the drum, taking care to seal the opening with the palm as it sealingly engages the flat rim or platform 72 around the entire periphery of the opening 60. During this sequence, the striking action creates a compression wave in the air enclosed by the body of the drum. The wave reverberates within and through the drum body, creating an audible pattern of vibration. The structure of the drum, and in particular the configuration of the chambers, both amplifies and sustains the vibration. If the membrane 30 or head of the drum is free to vibrate during this action, i.e., without damping from the user, the head 30 will vibrate sympathetically with the compression wave, substantially adding to the color of the sound.

Preferably, the drum has a range of natural resonance approximating that of a Major 12^{th}. The pitch of the drum can be controlled by partially or fully deflecting/interfering with the sound as it exits the sound hole 60 using the barrier member 80. For example, in one sequence, the player strikes the head 30 of the drum with one hand and places the other hand, used as the barrier member 80, immediately adjacent the sound hole 60. By varying the distance of the barrier member 60 from the sound hole 60, the user is able to change the wavelength of the sound(s) produced, and therefore the pitch. As the user moves the barrier member 80 closer to the sound hole 60, the pitch will be lowered. As the user moves the barrier member 80 away from the sound hole 60, the pitch will be raised. Preferably, the drum provides a variation in pitch that is fully chromatic, and which approximately spans the ratio of a Major 12^{th} from the lowest to the highest pitch.

The user also can control the timbre of the sounds produced by the drum. For example, in one sequence, the user partially or fully closes or opens the sound hole 60 using the barrier member 80. At the same time, or alternating therewith, the user strikes the head 30 in various ways and in various places. For example, the user can use their full hand to strike the center of the membrane 30, which produces a thick, rich bass note. Alternatively, the user can use their full hand to strike the membrane 30 along the rim 42 of the first section to produce a thick, ringing treble note. In other alternatives, the user can strike the drumhead in various locations using only one or more of their fingers so as to produce thinner sounds. All of these sounds can be further altered and shaped by the user by manipulating the sound hole while activating the drum head, or membrane.

As explained above, the user can manipulate the sound hole 60 both to produce sound and to manipulate the sound produced when the membrane 30 of the drum is struck. In playing the instrument, the user can rapidly alternate or combine the various sounds produced. The user can produce sound using the sound hole 60 alone by slapping or striking the hole 60 with the barrier member 80. Alternatively, the user can strike the membrane 30 of the drum while using the barrier member 80 to work the sound hole, by positioning the barrier member 80 adjacent the hole 60 in a spaced apart relationship therewith, by moving the barrier member 80 toward and away from the hole 60, or by covering at least a portion of the hole 60 with the barrier member 80.

The drum is designed in such a way that its basic, natural resonant sound contains at least two dominant frequencies: a “bass” note and a “treble” note. Preferably, the drum design, and in particular the configuration of the various chambers, holes and the membrane, produces pitches that are consistently that of a Major 12^{th} (C to g”) on the keyboard, or a frequency relationship or ratio of 1 to 3, where the higher pitch is three times the frequency of the lower pitch.

It should be understood that the term “longitudinal,” as used herein, means of or relating to length or the lengthwise direction, and in particular, the direction running from the head of the drum to the opening 60. Although in the preferred embodiment, it is shown that the longitudinal axis is linear, it should be understood that the longitudinal axis 20 can be curved, or curvilinear, with the various sections being curved along the axis.

Although the present invention has been described with reference to preferred embodiments, those skilled in the art will recognize that changes may be made in form and detail without departing from the spirit and scope of the invention. As such, it is intended that the foregoing detailed description be regarded as illustrative rather than limiting and that it is the appended claims, including all equivalents thereof, which are intended to define the scope of the invention.

What is claimed is:

1. A percussion instrument comprising:
a first section defining a first chamber having a first and second opening formed on opposite ends thereof;
a membrane secured over said first opening of said first chamber;
a second section defining a second chamber having a first and second opening on opposite ends thereof, said first opening of said second chamber communicating with said second opening of said first chamber; and
a third section defining a third chamber having a first and second opening formed on opposite ends thereof, said first opening of said third chamber communicating with said second opening of said second chamber, wherein said second opening of said third chamber remains exposed to a user, wherein said third chamber has a maximum cross-sectional area and wherein said second opening defines an area that is smaller than said maximum cross-section area of said third chamber.

2. The invention of claim 1 wherein said first and second openings of each of said first, second and third chambers are coaxially aligned along a longitudinal axis.

3. The invention of claim 1 wherein said third section has a spherical shape.

4. The invention of claim 1 wherein at least a portion of said first section has a frusto-conical shape.

5. The invention of claim 1 wherein said second section has a substantially cylindrical shape.

6. The invention of claim 1 wherein said first opening of said first chamber is larger than said second opening of said first chamber.

7. The invention of claim 1 wherein said first opening of said first chamber is larger than said second opening of said third chamber.

8. A percussion instrument comprising:
a first section defining a first chamber and having a first and second end, wherein said first end is wider than said second end, said first end having an opening formed therein and communicating with said chamber;
a membrane secured over said opening formed in said first end of said first chamber;
a tubular second section connected to said first section and defining a second chamber communicating with said first chamber; and
a substantially spherical third section connected to said second section and having an opening formed therein, said third section defining a substantially spherical third chamber communicating with said second chamber, wherein said opening in said third section is exposed.

9. The invention of claim 8 wherein said openings in said first and third sections are coaxially aligned along a longitudinal axis.

10. The invention of claim 8 wherein at least a portion of said first section has a frusto-conical shape.

11. The invention of claim 10 wherein said second section has an elongated, substantially cylindrical shape.

12. The invention of claim 8 wherein said first, second and third sections are coaxially aligned along a longitudinal axis.

13. The invention of claim 8 wherein said first, second and third sections are integrally formed.

14. The invention of claim 8 wherein said opening in said first section is larger than said opening in said third section.

15. A method of playing a percussion instrument comprising:
providing said percussion instrument comprising a first section defining a first chamber having an opening formed on one end thereof, a membrane secured over said opening of said first chamber, a second section connected to said first section and defining a second chamber communicating with said first chamber, and a third section connected to said second section and defining a third chamber having an opening formed on one end thereof, said third chamber communicating with said second chamber, wherein said third chamber has a maximum cross-sectional area and wherein said opening of said third chamber defines an area that is smaller than said maximum cross-sectional area of said third chamber; and
striking at least a portion of said membrane.

16. The invention of claim 15 further comprising placing a barrier member adjacent said opening of said third chamber.

17. The invention of claim 16 further comprising moving said barrier member toward and away from said opening of said third chamber.

18. The invention of claim 16 further comprising covering at least a portion of said opening of said third chamber with said barrier member.

19. The invention of claim 16 wherein said barrier member comprises a user's hand.

20. The invention of claim 15 further comprising striking said opening of said third chamber.

21. The invention of claim 20 wherein said striking comprises covering the entirety of said opening of said third chamber.

22. The invention of claim 15 wherein said openings of said first and third chambers are coaxially aligned along a longitudinal axis.

23. The invention of claim 15 wherein said opening of said first chamber is larger than said opening of said third chamber.

24. The invention of claim 15 wherein said first section has a first and second end, wherein said first end is wider than said second end, wherein said second section is tubular and wherein said third section has a substantially spherical shape.
